(19) United States
(12) Patent Application Publication
(10) Pub. No.: US 2005/0211455 A1
(43) Pub. Date: Sep. 29, 2005

(54) Signal connection device poke-thru assembly

(75) Inventor: Michael T. Cole, Williamstown, WV (US)

Correspondence Address: MCANDREWS HELD & MALLOY, LTD, 500 WEST MADISON STREET, SUITE 3400, CHICAGO, IL, 60661, US

(73) Assignee: The Wiremold Company

(21) Appl. No.: 11/141,758

(22) Filed: Jun. 1, 2005

Related U.S. Application Data
(63) Continuation of application No. 10/770,159, filed on Feb. 2, 2004.

(51) Int. Cl. H02G 3/04

(52) U.S. Cl. 174/48

(57) ABSTRACT

An in-floor fitting that is adapted to be inserted within an opening in a floor includes at least five signal connection devices, and a cover including doors over access paths to the signal connection devices. The doors are configured to be moved between open and closed positions.

### RELATED APPLICATIONS

This application is a continuation of Ser. No. 10/770,159, filed Feb. 2, 2004, entitled “Signal Connection Device Poke-Thru Assembly,” which is hereby incorporated by reference in its entirety.

### BACKGROUND OF THE INVENTION

In-floor fittings such as poke-thru fittings, afterset fittings, and preset fittings are installed in concrete floors to provide electrical receptacles and communication/data receptacles (or jacks) at desired locations in buildings. Poke-thru fittings are designed to be installed in an opening in a floor, such as a concrete slab or steel deck, in a building structure such as an office building to provide electrical receptacles and/or communication/data receptacles at desired locations in buildings. As a result, such fittings may be exposed to water, e.g. during carpet cleaning. It is desirable that such fittings are designed to prevent moisture infiltration from above the floor. In this respect, Underwriters Laboratories (UL) has proposed certification standards that require such fittings to keep scrub water out of the portion of the fitting that houses the electrical outlet, e.g. the power portion, and/or other devices therein, such as communication and audio/visual devices. Scrub water is a soap and water mixture that is typically used when cleaning carpets and other finished floor surfaces.

As explained in U.S. Pat. No. 4,770,643, source power and signal cables, loosely positioned in a plenum, which is between the ceiling of the floor below and the floor above (that is, the floor in which the opening is in), may be pulled from the plenum and connected with or passed through the poke-thru fitting for activation of services for and on the floor above. More specifically, high voltage source power cables are connected with power receptacles that may be mounted within the poke-thru fitting or surface mounted on the floor above the fitting. Lower voltage communication/data signal cables have traditionally been passed through the poke-thru fitting to provide above floor connections between these cables and equipment positioned on the floor above. More recently, poke-thru fittings have been developed that also provide for mounting the communication/data receptacle within the fitting.

Standards promulgated by Underwriters Laboratories (UL) require poke-thru fittings to enable the fire rating of the floor to be substantially the same with or without the floor opening and fitting therein. As a result, poke-thru fittings typically incorporate fire-retarding material, generally intumescent material, to retard the transmission of heat and flame from a fire in the plenum, for example. The intumescent material is activated upon exposure to a fire's heat and flames, rising through the floor opening from a fire below the floor. The intumescent material absorbs the heat and expands to fill open spaces in the floor.

Typical fire rated poke-thru assemblies include a housing for electrical outlets and/or telecommunication jacks. The assemblies are typically mounted in a core-drilled, approximately three or four inch diameter, hole within a concrete floor. U.S. Pat. No. 6,551,130, entitled “4×8 Fire Rated Poke Through Fitting,” issued to Bonilla (the “Bonilla patent”) discloses a poke through fitting having at least three electrical outlets and a plurality of telecommunication jacks. As shown in FIG. 1 of the Bonilla patent, the telecommunication jacks are standard telecommunication jacks and are open to the external environment. Scrub water may infiltrate the fitting in the Bonilla patent through the exposed telecommunication jacks. Further, the Bonilla patent does not disclose various other types of signal device connections. Instead, the Bonilla patent is limited to a fitting having a plurality of electrical outlets and a plurality of standard telecommunication jacks.

In various settings, such as within conference rooms having video and audio conferencing capabilities, a large number of telecommunication and audio/visual devices may be used. Typically, the wiring and cabling for these devices are routed to outlets and connections positioned within the floor and walls.

Thus, a need exists for a poke-thru assembly including a plurality of signal device connections that are protected from the external environment when not in use.

### SUMMARY OF THE INVENTION

Embodiments of the present invention provide an in-floor fitting that is adapted to be inserted within an opening in a floor. The in-floor fitting includes a plurality of signal connection devices, and a cover positioned over the plurality of signal connection devices. The cover includes a sliding door that is configured to slide through open and closed positions, wherein the plurality of signal connection devices are accessible when the sliding door is in the open position, and wherein the plurality of signal connection devices are protected from an external environment when the sliding door is in the closed position.

The plurality of signal connection devices may include a plurality of at least one of telecommunication jacks, coaxial jacks, fiber optic connectors, RCA style connectors, and audio/visual connection devices. The signal connection devices may be arranged such that a row of telecommunication jacks is perpendicular to a column of coaxial jacks and a parallel column of fiber optic connectors, and wherein a column of RCA style connectors are parallel to the columns of coaxial jacks and fiber optic connectors. The fitting may include at least eight signal connection devices.

The fitting also includes a trim flange having an interior compartment, a bezel secured within the interior compartment, wherein the plurality of signal connection devices are secured within the bezel, and a first plate connected to support legs mounted to the trim flange. A central space is defined between the trim flange and the first plate. At least a portion of the bezel is positioned within the central space so that the bezel and the plurality of signal connection devices do not extend upwardly past the cover.

The fitting also includes an intumescent insert, which may have a pocket configured to receive a lower portion of the bezel. The intumescent insert includes at least one tab that is received and retained within a notch formed in the first plate. The fitting also includes a second plate, wherein the intumescent insert is compressively sandwiched between the first and second plates.

The fitting may also include at least one electrical receptacle. The cover further includes an outlet sliding door positioned over the at least one electrical receptacle, wherein the outlet sliding door slides between open and closed positions to provide and restrict access to the electrical receptacle.

### BRIEF DESCRIPTION OF SEVERAL VIEWS OF THE DRAWINGS

FIG. 1 illustrates an isometric exploded view of a poke-thru assembly according to an embodiment of the present invention.

FIG. 2 illustrates an isometric view of an assembled poke-thru assembly according to an embodiment of the present invention.

FIG. 3 illustrates an isometric exploded view of a poke-thru assembly according to an alternative embodiment of the present invention.

FIG. 4 illustrates an isometric view of an assembled poke-thru assembly according to an alternative embodiment of the present invention.

FIG. 5 illustrates a top plan view of a poke-thru assembly according to an embodiment of the present invention.

FIG. 6 illustrates a top plan view of a poke-thru assembly according to an alternative embodiment of the present invention.

FIG. 7 illustrates a top plan view of a poke-thru assembly according to an alternative embodiment of the present invention.

FIG. 8 illustrates a top plan view of a poke-thru assembly according to an alternative embodiment of the present invention.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE INVENTION

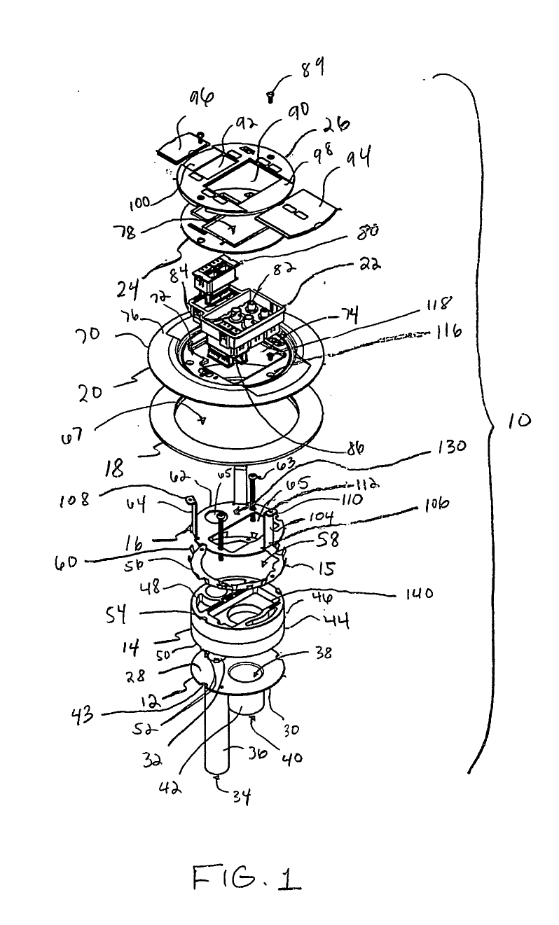

FIG. 1 illustrates an isometric exploded view of a poke-thru assembly 10 according to an embodiment of the present invention. The assembly 10 includes a bottom plate 12, an intumescent insert 14, a retaining ring 15, a top plate 16, an external gasket 18, a trim flange 20, a signal connection device bezel 22, an internal gasket 24, and a cover 26.

The bottom plate 12 includes an upper surface 28 and a lower surface 30. An opening 32 is formed from the upper surface 28 through the lower surface 30 and into a channel 34 defined by a cylindrical conduit 36. An opening 38 is formed from the upper surface 28 through the lower surface 30 and into a channel 40 defined by a cylindrical conduit 42. Notches 43 are formed at the outer edge of the bottom plate 12. The notches 43 are configured to receive tabs (discussed below) of the intumescent insert 14 in order to properly align the intumescent insert in relation to the bottom plate 12 during an assembly process. More or less notches 43 may be formed on the bottom plate 12 to receive and retain additional (or less) tabs of the intumescent insert 14.

The intumescent insert 14 includes a generally cylindrical main body 44 defined by an outer wall 46 and upper and lower surfaces 48, 50. Tabs 52 extend downwardly from the lower surface 50, while tabs 54 extend upwardly from the upper surface 48. More or less tabs 52 and 54 may extend from the intumescent insert 14 than the number shown in FIG. 1. The tabs 52 are configured to be received and retained by the notches 43 formed in the bottom plate 12. Similarly, the tabs 54 are configured to be received and retained by notches formed in the top plate 16.

The retaining ring 15 includes an annular body 56 having a central opening 58 defined therethrough. The retaining ring 15 also includes upwardly extending barbs 60 configured to securely retain the top plate 16.

The top plate 16 includes a generally circular main body 62 with upwardly extending support legs 64. The main body 62 includes a cavity 65 that may be configured to receive and securely retain the signal connection device bezel 22, and also allow signal wiring, cables, lines, and the like, to pass therethrough. Components of the assembly 10 are held in place due, in part, to stem screws 63 that pass through the top plate 16, the retaining ring 15, the intumescent insert 14 and the bottom plate 12.

Each upwardly extending support leg 64 includes an upright portion 104 having a first end 106 secured to the main body 62 of the top plate 16 and a second end 108 having a mounting tab 110. The mounting tab 110 includes a fastener through-hole 112. The mounting tabs 110 are configured to securely support the trim flange 20. The trim flange 20 includes fastener through-holes 116 that are configured to align with the fastener through-holes 112 of the mounting tabs 110. The trim flange 20 may be secured to the mounting tabs 110 through screws 118, nails, rivets, and the like. Alternatively, the trim flange 20 may include latching members, clasps, barbs, or the like that are configured to securably engage reciprocal structures formed on the mounting tabs 110. Optionally, the trim flange 20 may be integrally formed with, or bonded to, the top plate 16.

The annular external gasket 18 includes a central opening 67. The gasket 18 is configured to be compressively sandwiched between a bottom surface of the trim flange 20 and an upper surface of a floor, in order to prevent water from passing into the assembly 10.

The trim flange 20 includes an annular main body 70 having an interior compartment 72. The interior compartment 72 includes a mounting cavity 74 that receives and securely retains the signal connection device bezel 22.. The interior compartment 72 is recessed beneath a top surface 76 of the main body 70 such that the signal connection device bezel 22 is positioned at a lower position than the top surface 76.

The internal gasket 24 is sized to fit within the interior compartment 72 and provide a fluid tight barrier within the interior compartment 72. The internal gasket 72 includes openings 78 that provide access to and/or surround the signal connection device bezel 22.

The signal connection device bezel 22 includes a plurality of communication and/or audio visual connection devices. As shown in FIG. 1, the signal connection device bezel 22 carries standard telecommunication jacks 80, such as are used with telephones, coaxial cable jacks 82, fiber optic connectors 84, jacks 86, and various other communication, audio/visual and data devices. The jacks 86 may be standard telecommunication jacks or RCA style jacks. Optionally, the signal connection device bezel 22 may house any combination of the above connection devices. For example, the signal connection device bezel 22 may house only a plurality coaxial cable jacks 82, or only a plurality of jacks 86, or various combinations of telecommunication jacks 80, coaxial cable jacks 82, fiber optic connectors 84, and jacks 86. Further, the bezel 22 may accommodate various types, shapes and sizes of signal connection devices. For example, the bezel 22 may house a signal connection device configured to receive and retain an input plug for a microphone, overhead projection device, or various other types of presentation equipment.

Various types of communication and audio/visual connection devices may be used, such as category 5e, category 6, and similar type of jacks used for internet connections, standard telephone jacks, fiber optic connectors, RCA style jacks, and even audio/visual connection devices, such as are used with respect to audio/visual components (e.g., televisions, speakers, DVD players, microphones, overhead projection devices, slide projectors, and the like). For example, the signal connection device bezel 22 may include “video in,” “video out,” “audio in,” and “audio out” ports. As shown in FIG. 1, a total of eight (8) signal connection devices are shown. However, more or less than eight signal connection devices may be housed within the signal connection device bezel 22.

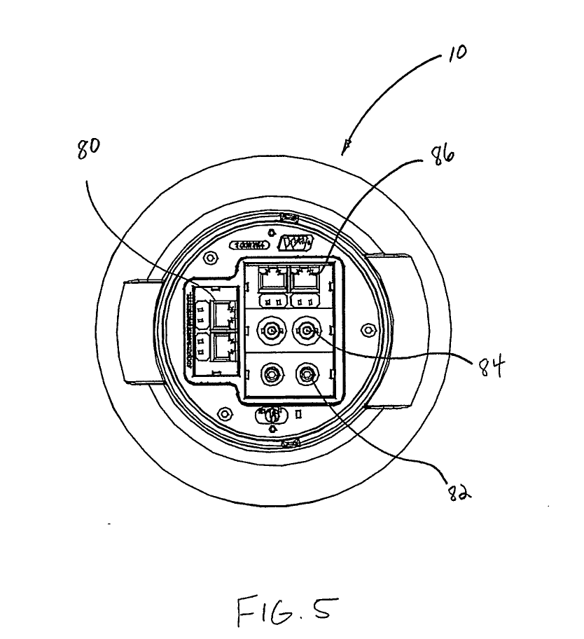

FIG. 5 illustrates a top plan view of the poke-thru assembly 10. The eight signal connection devices are oriented in a linear fashion such that the telephone jacks 80 are positioned in a straight line over columns of coaxial jacks 82, fiber optic connectors 84, and the jacks 86. That is, a row (or column) of two telephone jacks 80 are positioned over (or to the side of) a column (or row) of two fiber optic connectors 84 and a column of two coaxial jacks 82. The jacks 86 are positioned to one side of the column of fiber optic connectors 84, while the column of coaxial jacks 82 are positioned on the other side of the fiber optic connectors 84. Optionally, additional telephone jacks 80 may be used instead of the jacks 86. Further, additional fiber optic connectors 84 may be used in place of the coaxial jacks 82, or vice versa.

In order to protect the signal connection devices when the assembly 10 is not in use, a cover 26 is mounted over the signal connection device bezel 22. The cover 26 is positioned over the signal connection device bezel 22. The cover 26 may be snapably, threadably or latchably retained within the interior compartment 72 of the trim flange 20. Optionally, the cover 26 may be secured to the trim flange 20 by way of screws 89 or other such fasteners. Additionally, the cover 26 may be integrally formed with the trim flange 20.

The cover 26 includes access openings 90 and 92 that provide an access path to the signal connection devices within the assembly 10. Sliding doors 94 and 96 are slidably secured within slide tracks 98, 100, respectively. The tracks 98 and 100 are recessed beneath the top surface of the cover 26 so that the sliding doors 94 and 96 may slide therethrough. The sliding doors 94 and 96 may slide between open positions, in which one may access the signal connection devices positioned underneath, and closed positions, in which the signal connection devices are covered. More or less sliding doors may be used with the assembly 10. The sliding doors 94 and 96 slide in directions that are substantially parallel with the surface of the floor (not shown). Also, as shown in FIG. 1, the sliding doors 94 and 96 are configured to linearly slide. Optionally, the sliding doors 94 and 96 may be secured to the cover 26 at pivoting points to allow the sliding doors 94 and 96 to slide through open and closed positions in a swinging fashion.

The intumescent insert 14 is configured to be sandwiched between the bottom plate 12 and the top plate 16 with the retaining ring 15 positioned between the top plate 16 and the intumescent insert 14. The retaining ring 15 is configured to securely clamp into the floor (such as a concrete floor) by way of the barbs 60. When the assembly 10 is fully assembled, wiring, cabling, or the like connected to components within the signal connection device bezel 22 passes through an electrical passage defined by the cavity 74, the central opening 67, the cavity 65, the central opening 58, channels within the intumescent insert 14 and through channels 34 and/or 40.

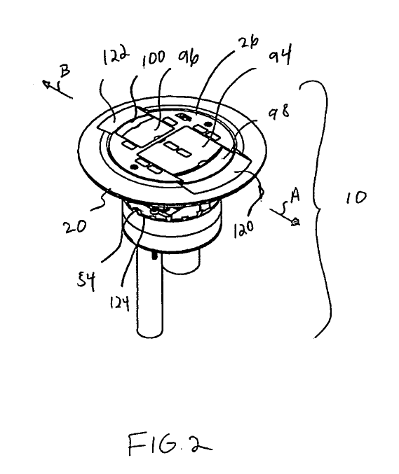

FIG. 2 illustrates an isometric view of a fully assembled poke-thru assembly 10. As shown in FIG. 2, the sliding doors 94 and 96 are in closed positions, thereby protecting the signal connection devices positioned underneath. The trim flange 20 includes recessed sliding tracks 120 and 122 that are aligned with the sliding tracks 98 and 100, respectively. The sliding door 94 slides in the direction of A in order to provide access to the signal connection devices within the assembly 10. The sliding door 94 slides through the tracks 98 and 120. Similarly, the sliding door 96 slides in the direction of B in order to provide access to the signal connection devices within the assembly 10. The sliding door 96 slides through the tracks 100 and 122.

As shown in FIG. 2, when the sliding doors 94 and 96 are in a closed position, the cover 26, including the sliding doors 94 and 96 is substantially flush with the surface of the floor (not shown). This is because the signal connection device bezel 22 (as shown in FIG. 1) is recessed within assembly 10. Referring again to FIG. 1, a top surface of the bezel 22 is positioned below the plane of the top surface 76 of the trim flange 20. The main body of the bezel 22 is positioned through the cavity 74 and into a central space 130 defined between a lower surface of the top plate 16 and a plane defined by a lower surface of the annular main body 70 of the trim flange 20. Thus, the assembly 10 is capable of housing a wide variety of signal connection devices of various shapes and sizes, while having a top surface, i.e., the cover 26, that is substantially flush with the surface of the floor, due to the recessed nature of the bezel 22.

Additionally, as shown in FIG. 1, the intumescent insert 14 includes a rectangular pocket 140 sized and configured to receive a lower portion of the bezel 22. Thus, the bezel 22 may extend into the intumescent insert 14, thereby allowing the bezel 22 to be located at a lower position within the assembly 10.

Also, as shown in FIG. 2, the tabs 54 of the intumescent insert are securely retained with notches 124 formed at the edges of the top plate 16. The mating of the tabs 54 within the notches 124 ensures proper alignment of components of the assembly 10. Similarly, as discussed above with respect to FIG. 1, the tabs 52 are securely retained within the notches 43 of the bottom plate 12.

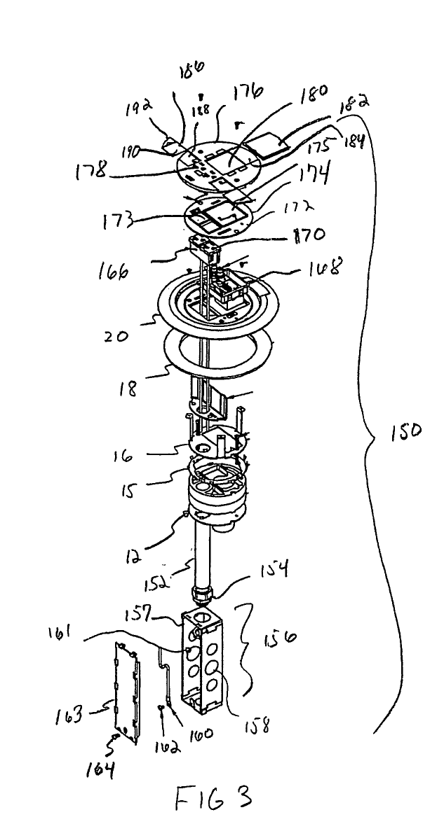

FIG. 3 illustrates an isometric exploded view of a poke-thru assembly 150 according to an alternative embodiment of the present invention. The assembly 150 is similar to the assembly 10, except that the assembly 150 includes power and signal connection devices. The bottom plate 12 includes an electrical conduit 152 that is connected to a fitting 154, which in turn connects to a junction box 156. The junction box 156 includes a main body 157 having passages 158 for conduits to connect thereto, so that power lines from the assembly 150 may be routed to other areas. A ground wire 160, which connects to a ground screw 162, is housed within the junction box 156. A cover 163 mounts over an open side 161 through one or more fasteners 164, such as screws.

A duplex receptacle 166 is housed within the assembly 150 along with a signal connection device bezel 168. The duplex receptacles 166 may be snapably secured within the trim flange 20. The signal connection device bezel 168 is similar to the bezel 22, except that the bezel 168 may not house as many signal device connections. As shown in FIG. 3, the assembly houses two 20 amp electrical receptacles 170 within the duplex receptacle 166 and a plurality of data/telephone/communication connection devices and/or a plurality of audio/visual connection devices. For example, the assembly 150 may house four telecommunication jacks or nine audio/visual connection devices.

An internal gasket 172 having a main body 174 with power and signal openings 173, 175 formed therethrough is positioned within the trim flange 20, under a cover 176. The gasket 172 is configured to prevent moisture infiltration into the assembly 150.

The cover 176 includes electrical access outlets 178 and a signal access opening 180. The cover 176 also includes a signal sliding door 182 that is configured to slide through slide track 184. Similarly, an outlet sliding door 186 is positioned within a slide track 188 located proximate each electrical access outlet 178. Each outlet sliding door 186 includes a covering portion 190 integrally formed with a raised handle 192. The outlet sliding doors 186 are configured to slide through the slide tracks 188 between open and closed positions. When in a closed position, the covering portion 190 is positioned underneath the electrical access outlet 178, but above a corresponding electrical receptacle 170, thereby providing a barrier between the external environment and the electrical receptacle 170.

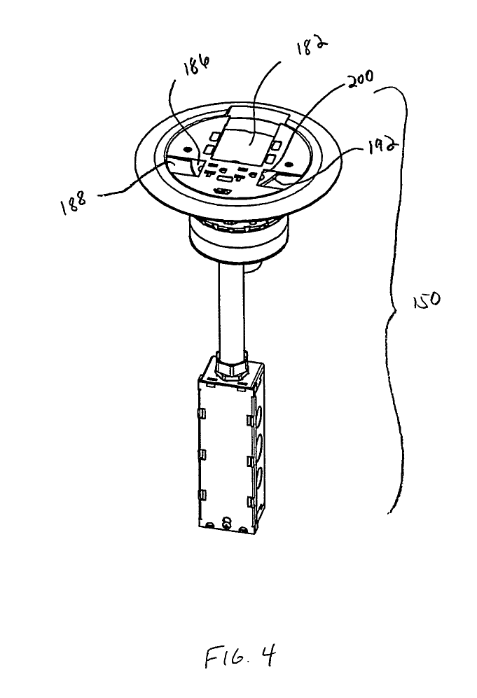

FIG. 4 illustrates an isometric view of the fully-assembled poke-thru assembly 150. As shown in FIG. 4, the signal sliding door 182 and outlet sliding doors 186 are in closed positions. The raised handles 192 of the outlet sliding doors 186 abut edges 200 bounding the sliding tracks 188 so that only the covering portion 190 is positioned beneath the electrical access outlets 178. In order to open the outlet sliding doors 186, the outlet sliding doors 186 are slid away from the electrical access outlets 178.

An upper surface of the assembly 150 is substantially flush with a surface of the floor (not shown), for the same reasons discussed above with respect to the assembly 10. That is, because the electrical receptacles 170 and the signal connection devices located within the bezel 168 are recessed within the assembly 150, and because the doors 182 and 186 slide in directions parallel with a plane of the floor, the assembly does not protrude appreciably above the floor surface.

Optionally, the outlet sliding doors 186 may slide over the access outlets 178 and/or may be configured to slidably swing through open and closed positions. Also, optionally, more or less electrical receptacles may be housed within the assembly than those shown in FIGS. 3 and 4.

The sliding doors shown in the embodiments described above may include a latching member located at a distal end. The latching member abuts again, or latches onto, an edge of the cover when the doors are in fully opened positions, so that the doors remain on the cover.

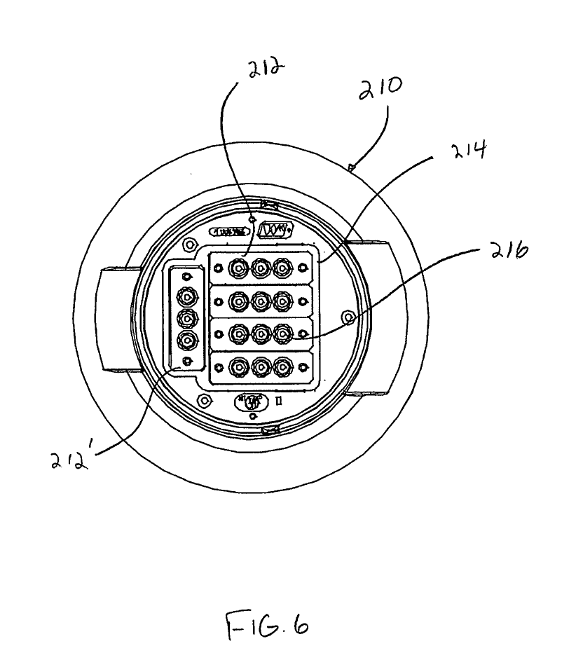

FIG. 6 illustrates a top plan view of a poke-thru assembly 210 according to an alternative embodiment of the present invention. For the sake of clarity the cover and sliding doors are not shown. In this embodiment, five audio/visual modules 212 are positioned within the bezel 214. Each module 212 houses three audio/visual connection devices 216. The audio/visual connection devices 216 may be coaxial connection devices, fiber optic connectors, or the like. As shown in FIG. 6, one module 212′ is positioned over (or to the side of) four parallel modules 212. Thus, the poke thru-assembly 210 accommodates a total of fifteen audio/visual connection devices 216.

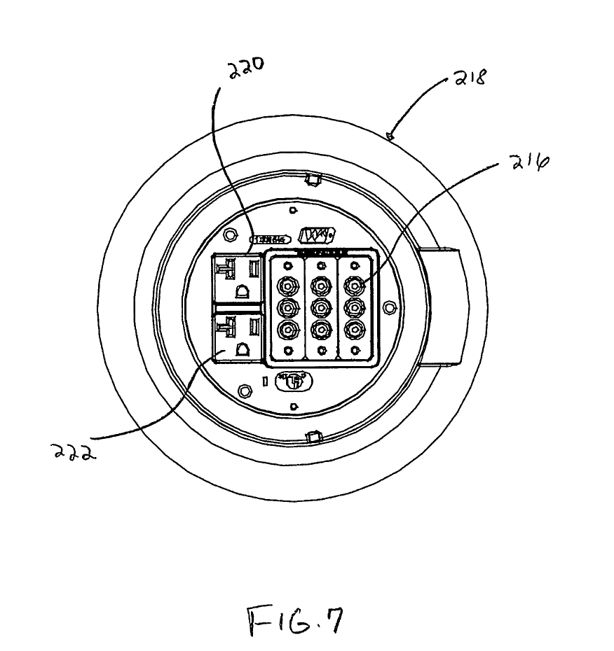

FIG. 7 illustrates a top plan view of a poke-thru assembly 218 according to an alternative embodiment of the present invention. For the sake of clarity the cover and sliding doors are not shown. The poke-thru assembly 218 is similar to the poke-thru assembly 210, except that a duplex electrical receptacle 220 having two 20 amp receptacles 222 is positioned to the side of (or over) three audio/visual modules 212. Thus, the poke-thru assembly 218 accommodates a total of nine audio/visual connection devices 216 and two electrical receptacles 222.

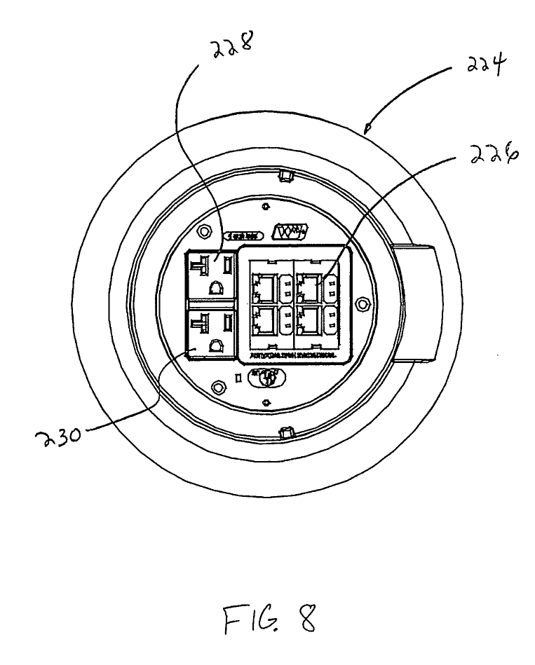

FIG. 8 illustrates a top plan view of a poke-thru assembly 224 according to an alternative embodiment of the present invention. For the sake of clarity the cover and sliding doors are not shown. The poke-thru assembly 224 houses four telecommunication connection devices 226 (such as standard telecommunication jacks, CAT 5 or 6 jacks, and the like), and a duplex receptacle 228. Thus, the poke-thru assembly 224 houses four telecommunication connection devices 226 and two electrical receptacles 230.

Thus, embodiments of the present invention provide a poke-thru assembly comprising a plurality of signal connection devices and/or electrical receptacles that are protected from the external environment when not in use.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. An in-floor fitting that is adapted to be inserted within an opening in a floor, comprising:
at least five signal connection devices; and
a cover comprising doors over access paths to said at least five signal connection devices, wherein said doors are configured to be moved between open and closed positions, wherein said at least five signal connection devices are accessible when said doors are in the open position, and wherein said at least five signal connection devices are protected from an external environment when said doors are in the closed position.

2. The in-floor fitting of claim 1, wherein said at least five signal connection devices comprise eight signal connection devices.

3. The in-floor fitting of claim 1, wherein said at least five signal connection devices comprise audio/visual connection devices.

4. The in-floor fitting of claim 1, wherein said at least five signal connection devices comprise at least one of telecommunication jacks, coaxial jacks, fiber optic connectors, RCA style connectors, and audio/visual connection devices.

5. The in-floor fitting of claim 1, wherein each of said doors is a sliding door.

6. The in-floor fitting of claim 5, wherein said sliding door is configured to slide in directions that are parallel to a surface of a floor.

7. The in-floor fitting of claim 1, further comprising:
a trim flange having an interior compartment, a bezel secured within said interior compartment, wherein said at least five signal connection devices are secured within said bezel;
a first plate connected to support legs mounted to said trim flange, wherein a central space is defined between said trim flange and said first plate, and wherein at least a portion of said bezel is positioned within said central space so that said bezel and said at least five signal connection devices do not extend upwardly past said cover.

8. The in-floor fitting of claim 7, further comprising an intumescent insert.

9. The in-floor fitting of claim 8, wherein said intumescent insert comprises a pocket configured to receive a lower portion of said bezel.

10. The in-floor fitting of claim 8, wherein said intumescent insert comprises at least one tab that is received and retained within a notch formed in said first plate.

11. The in-floor fitting of claim 8, further comprising a second plate, wherein said intumescent insert is compressively sandwiched between said first and second plates.

12. An in-floor fitting that is adapted to be inserted within an opening in a floor, comprising:
at least five signal connection devices; and
a door positioned over at least one of said at least five signal connection devices, said door being configured to be moved between open and closed positions, wherein said at least one of said at least five signal connection devices is accessible when said door is in the open position, and wherein said at least one of said at least five signal connection devices is protected from an external environment when said door is in the closed position.

13. The in-floor fitting of claim 12, wherein said at least five signal connection devices comprise eight signal connection devices.

14. The in-floor fitting of claim 12, wherein said at least five signal connection devices comprise audio/visual connection devices.

15. The in-floor fitting of claim 12, wherein said at least five signal connection devices comprise at least one of telecommunication jacks, coaxial jacks, fiber optic connectors, RCA style connectors, and audio/visual connection devices.

16. The in-floor fitting of claim 12, wherein said door is a sliding door.

17. The in-floor fitting of claim 16, wherein said sliding door is configured to slide in directions that are parallel to a surface of a floor.

18. The in-floor fitting of claim 12, further comprising:
a trim flange having an interior compartment, a bezel secured within said interior compartment, wherein said at least five signal connection devices are secured within said bezel;
a first plate connected to support legs mounted to said trim flange, wherein a central space is defined between said trim flange and said first plate, and wherein at least a portion of said bezel is positioned within said central space so that said bezel and said at least five signal connection devices do not extend upwardly past said cover.

19. The in-floor fitting of claim 18, further comprising an intumescent insert.

20. The in-floor fitting of claim 19, wherein said intumescent insert comprises a pocket configured to receive a lower portion of said bezel.

21. The in-floor fitting of claim 19, wherein said intumescent insert comprises at least one tab that is received and retained within a notch formed in said first plate.

22. The in-floor fitting of claim 19, further comprising a second plate, wherein said intumescent insert is compressively sandwiched between said first and second plates.

23. An in-floor fitting that is adapted to be inserted within an opening in a floor, comprising:
eight audio/visual connection devices; and
at least one door positioned over at least one of said eight audio/visual connection devices, said at least one door being configured to be moved between open and closed positions, wherein said at least one of said eight audio/visual connection devices is accessible when said at least one door is in the open position, and wherein said at least one of said eight audio/visual connection devices is protected from an external environment when said at least one door is in the closed position.

24. The in-floor fitting of claim 23, wherein said at least one door is a sliding door.

25. The in-floor fitting of claim 24, wherein said sliding door is configured to slide in directions that are parallel to a surface of a floor.
